(19) United States
(12) Patent Application Publication
(10) Pub. No.: US 2005/0040788 A1
(43) Pub. Date: Feb. 24, 2005

(54) Storage cell supplying power of different voltages

(75) Inventor: Wen Ing Tseng, Taichung City (TW)

Correspondence Address: TROXELL LAW OFFICE PLLC, SUITE 1404, 5205 LEESBURG PIKE, FALLS CHURCH, VA, 22041, US

(73) Assignee: INVOT Electronic Co.

(21) Appl. No.: 10/642,783

(22) Filed: Aug. 19, 2003

(51) Int. Cl. H02J 7/00

(52) U.S. Cl. 320/111

(57) ABSTRACT

A storage cell supplying power of different voltages includes a cell body, a control circuit, a rechargeable battery, plural sockets, two electrodes, a power cord, a universal cord, and a pair of jumper cables. Then this storage cell can be used as a temporary power source for various electrical appliances by using the universal cord provided with plugs to connect with different sockets of different electric appliances, and also can be used for jumpstarting a car with its own battery being dead.

### BACKGROUND OF THE INVENTION

1. Field of the Invention

This invention relates to a storage cell, particularly to one portable for a trip and capable to supplying power of different voltages for different electric appliances.

2. Description of Prior Art

As living standard has been elevated in recent years in addition to two day weekend holidays, more people go outdoors, camp in resorts frequently, and they will carry with them different kinds of electric appliances for enjoyment and use, such as mobile phones, laptop computers, portable CD players, radios, electric toys, etc. Those electric appliances almost use batteries, whose electricity may often used up or become short of electricity, and different appliances uses different kinds of batteries. So to prepare in advance spare batteries is quite troublesome. Especially, if a car battery becomes dead and cannot run, with a near garage impossible to reach, then it is a great trouble.

### SUMMARY OF THE INVENTION

The purpose of the invention is to offer a storage cell capable to supply power of different voltages for different electric appliances to be carried on a trip or a picnic. An additional purpose of the invention is to offer a storage cell portable for a trip connectable to a car for jump-start in case of the car battery is dead

The storage cell has a cell body, a control circuit, and a rechargeable battery. The cell body is provided with a power socket, a plurality of sockets respectively connected to the control circuit for transmitting different DC voltages. The cell body also has a pair of electrodes fixed in a recess in its outer surface and connected with the control circuit to supply DC of large current. And a power cord is provided, having one end provided with a power socket and the other end possible to be inserted in the power socket of the cell body for charging a rechargeable battery. Further, a universal cord is provided, having one end fixed with a plug possible to be inserted in one of the plural sockets of the cell body and the other end fixed with a connector for connecting various plugs so as to select a proper plug for various electric appliances to supply an electric appliance with the power of cell body. Additionally, two jumper cables are provided, with one end fixed with a socket and another end fixed with a pair of pincers for pinching a terminal of a car battery to jump-starting a car with its battery dead.

### BRIEF DESCRIPTION OF DRAWINGS

This invention will be better understood by referring to the accompanying drawings, wherein:

FIG. 1 is a perspective view of a first embodiment of a storage cell in the present invention;

FIG. 2 is a graph of an electric circuit of the first embodiment of a storage cell in the present invention; and,

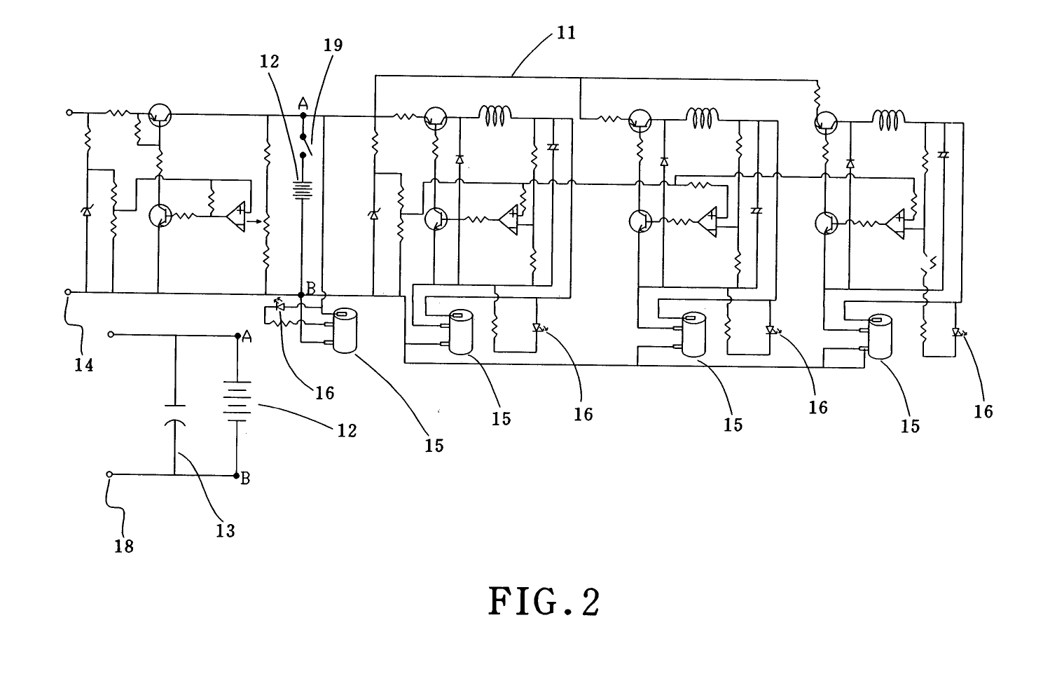

FIG. 3 is a perspective view of a second embodiment of a storage cell in the present invention.

### DETAILED DESCRIPTION OF THE PREFERRED EMBODIMENT

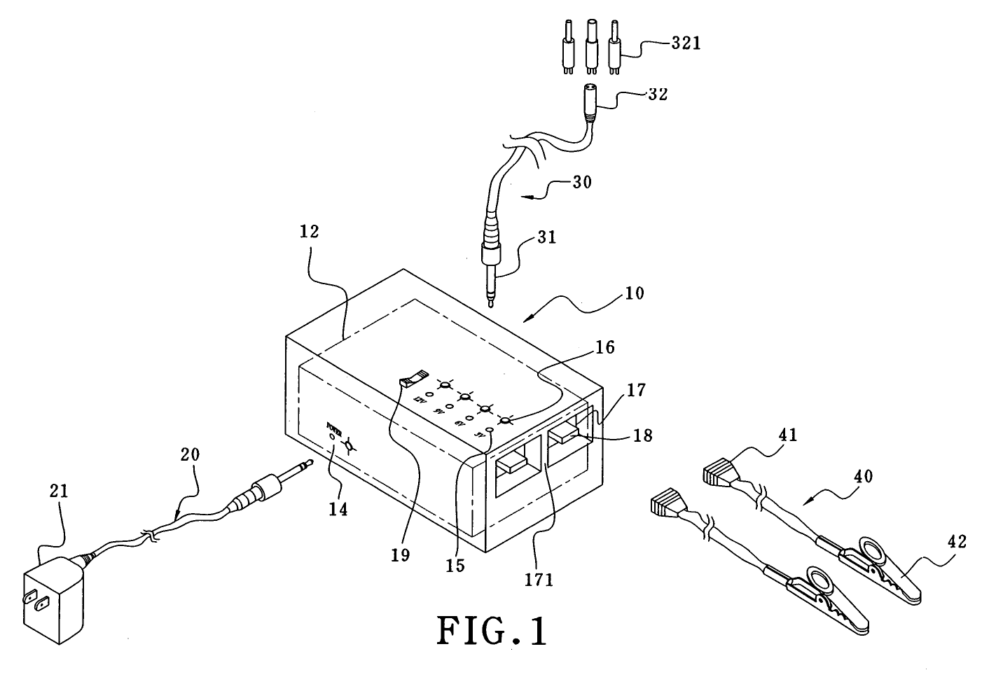

A preferred embodiment of a storage cell in the present invention, as shown in FIG. 1, includes a cell body 10, a power cord 20, a universal cord 30, and a pair of jumper cables 40 as main components.

The cell body 10 is rectangular, having a control circuit 11 arranged in its interior, a rechargeable battery 12 connected to the control circuit 11 fixed in its interior, a large capacitor 13 connected in series with the rechargeable battery 12 to produce large current at the moment of discharging of the rechargeable battery 12, a power insert hole 14 fixed on an outer surface, a plurality of sockets 15 for supplying DC of different voltages also fixed on the outer surface and connected to the control circuit 11. The sockets 15 according to this embodiment are respectively 12V, 9V, 6V, and 3V, and affixed with an indicating lamp 16 for marking. The cell body further has a recess 17 formed on the outer surface, and a pair of electrodes 18 positioned in the recess 17, and a separating wall 171 located between the two electrodes 18 to prevent the electrodes 18 from contacting each other to short-circuit. The pair of electrodes 18 is connected to the control circuit 11 for supplying DC of large current. A power switch 19 is further provided on the outer surface of the cell body 10, connected in series with the rechargeable battery 12. So if the power switch is turned off, the rechargeable battery 12 may not leak electricity so as to maintain its electricity as much as possible.

The power cord 20 has a power plug 21 at one end to connect to power, with the power plug 21 being a common converting plug available in the market, and the other end possible to be inserted in the insert hole 14 of the cell body 10 for electric current to flow to the control circuit 11 for charging the rechargeable battery 12.

The universal cord 30 has a plug 31 at one end to insert in one of the sockets 15, and a connector 32 at the other end for selectably connecting various plugs 321 of different shapes and sizes to adapt to any electric appliances.

The jumper cables 40 respectively have a rather large diameter, having a socket 41 at one end to connect with the electrodes 18 and a pair of clamps 42 at the other end to pinch a terminal of a car battery so as to jump-start a car the its battery being dead.

When the storage cell of the invention is to be used for charging, the plug of the power cord 20 is inserted in the power hole 14 of the cell body 10, and the socked 21 is inserted in a socket of a utility line. In case the storage cell is to be used as a power for an electric appliance, the proper one of the sockets 15 of the same voltage as that of the appliance is selected, and the plug 31 of the universal cord 30 is inserted in that socket 15, with the connector 32 of the same cord 30 connected with the proper one of the plugs 321 and inserted. in a power hole of the appliance. If the storage cell is to be used for jumpstarting a car, the sockets 41 are connected with the electrodes 18 of the storage cell 10, with the clamps 42 pinching the terminals of the car battery. Then the electrodes 18 may produce instant large current to jumpstart the car.

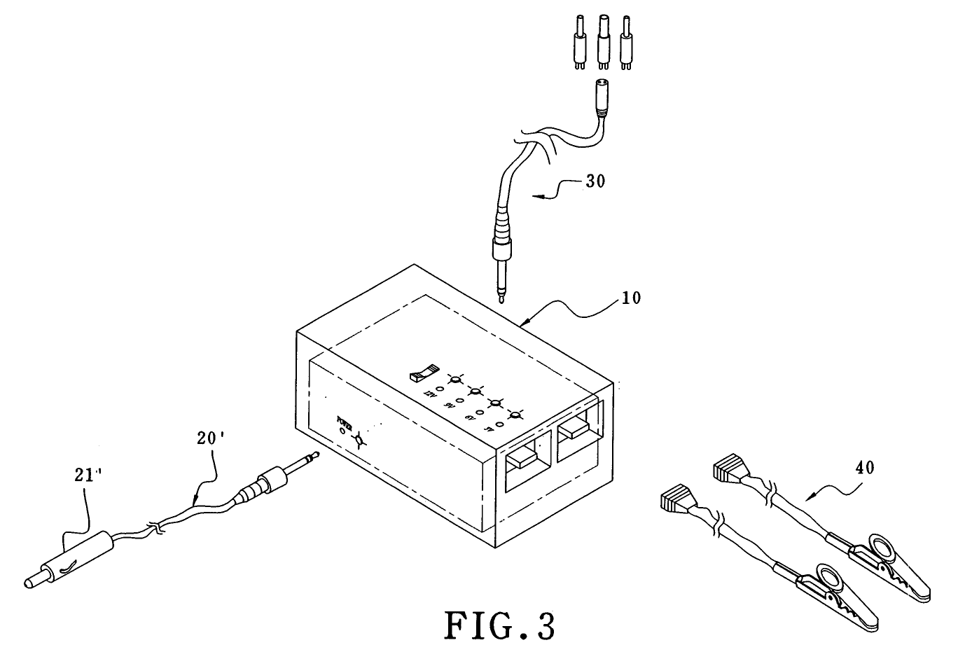

Next, FIG. 3 shows a second embodiment of the storage cell of the invention, having almost the same structure of the first embodiment except a plug 21′ of a car cigarette lighter instead of the socket 21, for carrying out charging.

The storage cell according to the invention has the following advantages.
1. It has plural sockets 15 for supplying power of different voltages, and the universal cord 30 has plural different plugs 31 permitting it applicable to various electric appliances.
2. The plural sockets 15 together with more than one universal cord 30 can permit it usable as temporary power sources for more than two kinds of electric appliances at the same time.
3. It has a pair of electrodes 18 so it can be used for jumpstarting a car in conjunction with the car cord, in case of the car battery being dead.

While the preferred embodiment of the invention has been described above, it will be recognized and understood that various modifications may be made therein and the appended claims are intended to cover all such modifications that may fall within the spirit and scope of the invention.

1. A storage cell supplying power of different voltages, said storage cell comprising:
A cell body having a control circuit arranged in its interior, a rechargeable battery also positioned in its interior and connected with said control circuit, a power insert hole formed in an outer surface, a plurality of sockets formed in the outer surface of said cell body and connected with said control circuit for supplying power of different voltages, and two electrodes formed at the outer surface and connected with said control circuit for supplying DC of instant large current:
A power cord having a power plug at one end for connecting with power and the other end inserting in said power insert hole of said cell body for charging said rechargeable battery by means of said control circuit:
At least a universal cord having a plug at one end to insert in one of said sockets of said cell body, a connector at the other rend, said connector provided with a plurality of different plugs, one of said connector plugs selected to connect with said connector so as to fit in a power hole of an electric appliance to be used: and,
A pair of jumper cables respectively having a sockets at one end to connect with each said electrode of said cell body and a clamp at the other end for pinching a terminal of a car battery so as to jumpstart a car.

2. The storage cell as claimed in claim 1, wherein said rechargeable battery is further connected with a large capacitor in order to permit said rechargeable battery produce instant large current in releasing electricity.

3. The storage cell as claimed in claim 1, wherein said power plug of said power cord is a plug of a car cigarette lighter to insert in a car cigarette lighter in a car for using the electricity of the car battery.

4. The storage cell as claimed in claim 1, wherein said power plug of said power cord is a common converting plug on the market in order to insert in a socket of a public utility as a power.

5. The storage cell as claimed in claim 1, wherein said plural sockets of said cell body are respectively provided with an indicating lamp.

6. The storage cell as claimed in claim 1, wherein said control circuit has a power switch fixed at the outer surface of said cell body.

7. The storage cell as claimed in claim 1, wherein said two electrodes are positioned in a recess formed in the outer surface and separated by a separating wall to prevent said two electrodes from contacting each other to produce short-circuit.
